(19) United States
(12) Patent Application Publication
(10) Pub. No.: US 2006/0043001 A1
(43) Pub. Date: Mar. 2, 2006

(54) Desulfurization system and method for desulfurizing afuel stream

(75) Inventors: Eric J. Weston, Shepherdsville, KY (US); R. Steve Spivey, Louisville, KY (US); Kerry C. Weston, Louisville, KY (US)

Correspondence Address: Scott R. Cox;LYNCH, COX, GILMAN & MAHAN, PSC, Suite 2100, 500 W. Jefferson St., Louisville, KY, 40202, US

(73) Assignees: Sud-Chemie Inc., Louisville, KY (US); Zeochem, LLC., Louisville, KY (US)

(21) Appl. No.: 11/207,154

(22) Filed: Aug. 18, 2005

Related U.S. Application Data
(63) Continuation-in-part of application No. 10/932,177, filed on Sep. 1, 2004.

(51) Int. Cl. C10G 25/00; B01J 8/02; B01J 29/06; B01J 29/08

(52) U.S. Cl. 208/208 R; 208/228; 208/249; 208/303; 208/246; 422/211; 502/79; 502/64

(57) ABSTRACT

A method for producing a substantially desulfurized hydrocarbon fuel stream at temperatures less than 100° C. including providing a nondesulfurized fuel cell hydrocarbon fuel stream and passing the fuel stream through a sequential sulfur adsorbent bed system containing at least one selective sulfur adsorbent and a calcium exchanged zeolite to produce a substantially desulfurized hydrocarbon fuel stream.

### CROSS REFERENCED TO RELATED APPLICATIONS

This application is a continuation-in-part application based on application Ser. No. 10/923,177 filed on Sep. 1, 2004.

### BACKGROUND OF INVENTION

The present invention relates to a novel method for producing a substantially desulfurized hydrocarbon fuel stream, particularly for hydrogen generation, and more particularly utilized within a fuel cell processing train, by passing a nondesulfurized hydrocarbon fuel stream, particularly natural gas, propane or liquefied petroleum gas (LPG), through a sequential sulfur adsorbent bed system at temperatures less than 100° C., wherein the sequential sulfur adsorbent bed system contains a zeolite sulfur adsorbent and at least one selective sulfur adsorbent. The present invention further relates to a system for generating electricity within a fuel cell processing train from a substantially desulfurized hydrocarbon fuel stream, particularly desulfurized natural gas, propane or LPG, wherein the hydrocarbon fuel stream is desulfurized using the above-described sequential sulfur adsorbent bed system. The present invention further includes a desulfurization system used for hydrogen generation, particularly within a fuel cell processing train for desulfurizing hydrocarbon fuel streams, particularly natural gas, propane or LPG, at temperatures as low as ambient temperatures.

For hydrogen generation, particularly for use in a conventional low temperature fuel cell processing train, such as a proton exchange membrane (PEM) fuel cell, which is suitable for use in a stationary application or in a vehicle, such as an automobile, the hydrocarbon fuel stream can be derived from a number of conventional fuel sources with the preferred fuel sources including natural gas, propane and LPG. In a conventional hydrogen generation system, particularly a fuel cell processing train, the hydrocarbon fuel stream is passed over and/or through a desulfurization system to be desulfurized. The desulfurized hydrocarbon fuel stream for such fuel cell processing train then flows into a reformer wherein the fuel stream is converted into a hydrogen-rich fuel stream. From the reformer the fuel stream passes through one or more heat exchangers to a shift converter where the amount of CO in the fuel stream is reduced. From the shift converter the fuel stream again passes through various heat exchangers and then through a selective oxidizer or selective methanizer having one or more catalyst beds, after which the hydrogen rich fuel stream flows to the fuel cell stack where it is utilized to generate electricity.

Raw fuels, in gaseous or liquid phase, particularly natural gas, propane and LPG, are useful as a fuel source for hydrogen generation, particularly for fuel cell processing trains. Unfortunately, virtually all raw fuels contain relatively high levels, up to as high as 1,000 ppm or so, but typically in the range of 20 to 500 ppm, of various naturally occurring sulfur compounds, such as, but not limited to, carbonyl sulfide, hydrogen sulfide, thiophenes, such as tetra hydro thiophene, dimethyl sulfide, various mercaptans, disulfides, sulfoxides, other organic sulfides, higher molecular weight organic sulfur compounds, and combinations thereof. In addition, because hydrocarbon fuel streams, particularly natural gas, propane and LPG, may have different sources of origin, the quantity and composition of the sulfur compounds that may be present in the fuel streams can vary substantially.

The presence of these sulfur-containing compounds in a hydrocarbon fuel stream can be very damaging to components of the fuel cell processing train, including the fuel cell stack itself, and must therefore be substantially removed. If not substantially removed, the sulfur compounds shorten the life expectancy of components of the fuel cell processing train.

An especially efficient desulfurization system is necessary for use in such fuel cell processing trains as they generally only contain a single desulfurization system. Further, desulfurization systems for such uses must have high capacity, as they may need to be in use for an extended period of time before replacement.

Several processes, conventionally termed “desulfurization,” have been employed for the removal of sulfur from gas and liquid fuel streams for hydrogen generation. Adsorption of sulfur-contaminated compounds from these hydrocarbon streams using a “physical” sulfur adsorbent is the most common method for removal of sulfur compounds from such hydrocarbon fuel streams because of their relatively low capital and operational costs. (For purposes of this specification, the terms “adsorption” and “absorption” have the same, all inclusive meaning.) While physical adsorbents are useful, they can be subject to desorption of the sulfur compounds from the adsorbent under certain operating conditions. In addition, there are often limits on the quantity of sulfur compounds which can be adsorbed by such physical sulfur adsorbents.

An additional type of adsorbent that has been useful as a desulfurization agent is a “chemical” sulfur adsorbent. However, chemical desulfurization normally requires the desulfurization bed to be heated to temperatures of about 150° C. to 400° C. before the nondesulfurized hydrocarbon fuel streams can be passed through the chemical adsorbent desulfurization system. In addition, other operational problems may occur when chemical desulfurization processes are utilized.

While many different desulfurization processes have been suggested for hydrocarbon fuel streams, there is still a need for improved processes for desulfurization to achieve enhanced adsorption of sulfur components over an extended range of sulfur concentrations, especially at relatively low operating temperatures and pressures, for extended periods of time. Further, there is a need for the desulfurization system to adsorb substantial quantities of a wide range of sulfur compounds, including particularly hydrogen sulfide, carbonyl sulfide, tetra hydro thiophene, dimethyl sulfide, various mercaptans, disulfides, sulfoxides, other organic sulfides, various higher molecular weight sulfur-containing compounds and combinations thereof. Further, it is important that the desulfurization system absorb this broad range of sulfur compounds effectively for an extended period of time to delay “breakthrough” of sulfur compounds as long as possible. “Breakthrough” occurs when the level of any sulfur compound remaining in the feed stream after desulfurization is above a predetermined level. Typical “breakthrough” levels for sulfur compounds occur at 1 ppm or so. In addition, breakthrough by virtually any one of the sulfur compounds present in the hydrocarbon fuel stream is disadvantageous as substantially all sulfur compounds cause damage to components of a hydrogen generation system, particularly for a fuel cell processing train.

In addition, some prior art adsorbents, while effective as adsorbents for some sulfur compounds, can synthesize the production of additional sulfur compounds even as they are removing some of the sulfur compounds that are present in the hydrocarbon fuel stream. (These additional sulfur compounds are referred to herein as “synthesized sulfur compounds.”) It is important that the desulfurization system avoid the production of these synthesized sulfur compounds to the greatest extent possible and for the longest period of time possible.

These and further aspects of the invention will be apparent from the foregoing description of preferred embodiments of the invention.

### SUMMARY OF INVENTION

The present invention is a process for supplying a substantially desulfurized hydrocarbon fuel stream for hydrogen generation, particularly for use in a fuel cell processing train comprising providing a nondesulfurized hydrocarbon fuel stream, preparing a desulfurization system comprising a sequential sulfur adsorbent bed system comprising a calcium exchanged zeolite sulfur adsorbent and at least one selective sulfur adsorbent, and passing the nondesulfurized hydrocarbon fuel stream through or over the desulfurization system at a temperature optimally less than about 100° C. to produce a substantially desulfurized hydrocarbon fuel stream with desulfurization levels as low as about 50 ppb or so. The composition and choice of the selective sulfur adsorbent(s) and the sequence of use of the selective sulfur adsorbent(s) and the calcium exchanged zeolite within the desulfurization system depends on the composition of the sulfur compounds which are present in that fuel stream.

The invention is also a system for generating electricity from a fuel cell processing train by use of a substantially desulfurized hydrocarbon fuel stream comprising preparing a fuel cell processing train containing the desulfurization system described above, passing a nondesulfurized hydrocarbon fuel cell fuel stream through the desulfurization system at a temperature preferably less than about 100° C., and introducing the substantially desulfurized hydrocarbon fuel stream to the remaining components of the fuel cell processing train.

The invention is also a desulfurization system for hydrogen generation, particularly for use in a fuel cell processing train, comprising an inlet for receiving a nondesulfurized hydrocarbon fuel stream, particularly natural gas, propane or LPG, the sequential adsorbent bed system described above, and an outlet for passing a substantially desulfurized hydrocarbon fuel stream downstream to the remaining components of the hydrogen generation system.

The invention is also a sequential sulfur adsorbent bed system for hydrogen generation, particularly for use in a fuel cell processing train comprising selective sulfur adsorbent(s) and a calcium exchanged zeolite. The choice of the particular selective sulfur adsorbent or absorbents and the sequence of use of the selective sulfur adsorbent or absorbents and the zeolite within the sequential sulfur adsorbent bed depends upon the composition and quantity of the sulfur compounds that are present in the hydrocarbon fuel stream. One or more selective sulfur adsorbents can be utilized with the calcium exchanged zeolite to form the sequential adsorbent bed system of the invention. One particularly preferred selective sulfur adsorbent comprises one or more manganese compounds, iron oxide and a high surface area carrier, particularly alumina. An alternative preferred selective sulfur adsorbent comprises one or more manganese compounds, copper oxide and a binder material.

### BRIEF DESCRIPTION OF DRAWINGS

FIG. 1 is a graph showing the performance of the calcium exchanged zeolite discussed in Example 1 for the removal of certain sulfur compounds from a synthetic natural gas feed stream.

FIG. 2 is a graph showing the performance of the selective sulfur adsorbent of Example 2 for the removal of the sulfur compounds of Example 1 from the synthetic natural gas feed stream of Example 1.

FIG. 3 is a graph showing the performance, as discussed in Example 3, of a combination of the zeolite of Example 1 with the selective sulfur adsorbent of Example 2 for the removal of the sulfur compounds of Example 1 from the synthetic natural gas feed stream of Example 1.

### DISCLOSURE OF A PREFERRED EMBODIMENT OF THE INVENTION

The invention includes a method for supplying a substantially desulfurized hydrocarbon fuel stream to a hydrogen generation system, particularly a fuel cell processing train. Raw fuel for use in such a hydrogen generation system, particularly a fuel cell processing train, such as natural gas, propane and LPG, must be desulfurized prior to use because of the presence of relatively high levels of naturally occurring sulfur compounds, such as, but not limited to, hydrogen sulfide, carbonyl sulfide, thiophenes, such as tetra hydro thiophene, dimethyl sulfide, mercaptans (including ethyl, methyl, propyl and tertiary butyl mercaptan), other sulfides, various higher molecular weight organic sulfur compounds and combinations thereof. These sulfur compounds can damage components of the hydrogen generation system and the fuel cell processing train. While numerous combinations and quantities of these sulfur compounds may be present in the fuel stream, in some situations, the sulfur compounds present in the fuel stream may be limited to only one or two such sulfur compounds. Where the raw fuel stream comprises natural gas, which is in a gaseous state at operating temperatures below 100° C., the level of sulfur compounds, such as carbonyl sulfide, hydrogen sulfide, tetra hydro thiophene, dimethyl sulfide, mercaptans, other organic sulfur compounds, and combinations thereof may be as high as about 100 ppm. The presence of such high levels of sulfur compounds, if not removed, results in the poisoning of components of the fuel cell processing train and may foul the fuel cell stack itself. Substantially complete removal of all of the sulfur compounds is necessary as the presence of even modest quantities of even a single sulfur compound can damage the components of the fuel cell processing train.

While the desulfurization system of the invention can be utilized for a number of different hydrogen generation processes, one particularly preferred utilization is within a fuel cell processing train. For purposes of this specification all hydrogen generation systems are included, although one preferred use is within a fuel cell processing train.

The inventors have surprisingly discovered that substantial desulfurization of a hydrocarbon fuel stream for fuel cell processing trains down to levels as low as 50 ppb or so can be achieved when a sequential sulfur adsorbent bed system is used as the desulfurization system comprising one or more selective sulfur adsorbents used in combination with a zeolite adsorbent, particularly a calcium exchanged zeolite, more particularly a calcium exchanged X zeolite. The composition and sequence of use of the components of the sequential sulfur adsorbent bed system can be adjusted depending on the composition and quantity of the sulfur compounds that are present in the hydrocarbon feed stream.

The selective sulfur adsorbent(s) of the invention is selected from a wide variety of adsorbents. As used within this application a “selective sulfur adsorbent” is a material that preferentially absorbs at least one of the sulfur compounds that are commonly present in hydrocarbon fuel cell fuel streams, particularly natural gas, propane or LPG, such as hydrogen sulfide, carbonyl sulfide, tetra hydro thiophene, dimethyl sulfide, mercaptans, particularly ethyl, methyl, propyl, and tertiary butyl mercaptans and combinations thereof, at a temperature below about 100° C. and pressures of about 10-250 psig or so.

Each selective sulfur adsorbent selectively adsorbs one or more of the sulfur compounds that are commonly present in the hydrocarbon fuel cell fuel stream, preferably natural gas. However, each of these adsorbents may be less or more effective than other of the selective sulfur adsorbents for the adsorption of particular sulfur compounds or combinations of these compounds. Further, additional problems can be created in the feed stream when some of the selective sulfur adsorbents are used alone as the sulfur adsorbent, as these selective sulfur adsorbents can synthesize existing sulfur compounds into different, higher molecular weight synthesized sulfur compounds that are not removed from the fuel stream by the particular selective sulfur adsorbent.

It has been surprisingly discovered that the desulfurization system can be substantially enhanced by utilizing a zeolite adsorbent particularly a calcium exchanged zeolite, and more particularly a calcium exchanged X zeolite, in combination with the selective sulfur adsorbent. Further, adsorption of a broader range of sulfur compounds from the hydrocarbon fuel cell fuel streams may occur when more than one selective sulfur adsorbent is used in combination with the zeolite adsorbent in the sequential sulfur adsorbent bed system. In particular, the combination of one or more selective sulfur adsorbents with the calcium exchanged zeolite adsorbent performs surprisingly better than the individual selective sulfur adsorbents or the calcium exchanged zeolite when used individually. In addition, the choice and arrangement of the selective sulfur adsorbent(s) and the zeolite within the sequential sulfur adsorbent bed system can reduce the likelihood of the production of synthesized sulfur compounds that are sometimes created when only a single selective sulfur adsorbent is utilized in the desulfurization system.

It has been further discovered that the removal of various combinations of sulfur compounds can be enhanced by the specific arrangement of the adsorbents in the sequential sulfur adsorbent bed system. For example, for the removal of one type or group of sulfur compounds, it is preferable to place the calcium exchanged zeolite in the sequential sulfur adsorbent bed prior to the selective sulfur adsorbent while for other sulfur compounds or combinations of sulfur compounds, it is preferable for the non-desulfurized hydrocarbon fuel cell fuel stream to contact one of the selective sulfur adsorbents prior to contacting the calcium exchanged zeolite. For other non-desulfurized hydrocarbon fuel cell fuel streams, it may be preferable to use two or more selective sulfur adsorbents, wherein one or more of these selective sulfur adsorbents are placed before or after the zeolite adsorbent in the sequential sulfur adsorbent bed system.

Sulfur adsorption by this system is further enhanced because some sulfur compounds, which may be synthesized to larger and more difficult to remove sulfur compounds by a particular selective sulfur adsorbent, are removed from the feed stream by the zeolite adsorbent, particularly the calcium-exchanged zeolite adsorbent, prior to synthesis by the selective sulfur adsorbent.

Suitable selective sulfur adsorbents are selected from a group of adsorbents including, but not limited to, a group of manganese-based adsorbents, such as an adsorbent comprising substantially manganese compounds, an adsorbent which includes manganese compounds, copper oxide and a binder and an adsorbent which includes manganese compounds, iron oxide and a high surface area carrier, particularly alumina. Other useful selective sulfur adsorbents for this desulfurization system may include, but are not limited to, zinc oxide with or without a carrier, such as alumina; activated carbon with copper oxide; a zinc oxide/copper oxide blend preferably containing small quantities of carbon and alumina; copper oxide with alumina; and a copper oxide/zinc oxide blend mixed with alumina. Other useful selective sulfur adsorbents may include nickel on silica or alumina and other known selective sulfur adsorbents containing copper, zinc, molybdenum and cobalt compounds. Various quantities of the individual components of each of these selective sulfur adsorbents can be utilized and the quantity of the individual components can be modified to enhance the adsorption capacity of the overall desulfurization system, depending on the particular sulfur compounds that are present in the hydrocarbon fuel cell fuel stream and the quantity thereof.

In one particularly preferred embodiment, the selective sulfur adsorbent contains one or more manganese compounds blended with iron oxide on a high surface area support, preferably a high surface area support comprising alumina, silica, silica-alumina, titania, and other inorganic refractory oxides, with a more preferred support being a high surface area alumina. By “high surface area” the inventors are describing a support with a surface area greater than about 100 m²/g.

The inventors have surprisingly discovered that the ability of the manganese compound(s)/iron oxide selective sulfur adsorbent to adsorb sulfur compounds is enhanced when the high surface area support is a high surface area alumina. Adsorbents comprising manganese compound(s)/iron oxide materials with high surface area alumina perform better and adsorb higher levels of sulfur compounds than when the carrier comprises other inorganic materials, even with similar surface areas. Any type of alumina with a surface area above about 100 m²/g is within the scope of the invention. The preferred carrier comprises from about 5 to about 25% by weight, preferably from about 5 to about 20% by weight, and most preferably from about 5 to about 15% by weight of the total weight of this selective sulfur adsorbent. The primary function of the support material is to provide a large and accessible surface area for deposition of the active metal compounds.

The metal compounds which are deposited on or with the high surface area support of this selective sulfur adsorbent, other than the one or more manganese compound(s), include iron oxide. In a preferred embodiment the iron oxide and manganese compound(s) together comprise at least about 60% by weight, preferably at least about 70% by weight and most preferably at least about 80% to about 90% of this selective sulfur adsorbent, by weight.

In a preferred embodiment the quantity of iron oxide present in this selective sulfur adsorbent exceeds the quantity of the manganese compound(s). It is preferred that the ratio of the iron oxide to the manganese compound(s) by weight, should be at least about 1:1 and preferably from about 1:1 to about 6:1. The preferred loading of iron oxide on the support is in the range of about 40 weight percent to about 80 weight percent and, more preferably from about 50 to about 70 weight percent of the total weight of the selective sulfur adsorbent. Various forms of iron oxide may be used, such as FeO and Fe₂O₃ and mixtures thereof. The one or more manganese compound(s) comprise from about 15 weight percent to about 40 weight percent, preferably from about 20 weight percent to about 40 weight percent of the total weight of the selective sulfur adsorbent. Various forms of manganese compounds can be used including MnO₂, Mn₂O₃, Mn₃O₄ and Mn(OH)₄ and mixtures thereof.

A promoter or promoters may also be added to this selective sulfur adsorbent, preferably an alkali or alkaline earth metal oxide and more preferably calcium oxide, in quantities from about 5 to about 15% by weight. While calcium oxide is the preferred promoter, other alkali or alkaline earth metal oxides, such as magnesium oxide, may also, or alternatively, be utilized with the calcium oxide.

The iron oxide/manganese compound(s) selective sulfur adsorbent according to the present invention may be prepared by coprecipitation, decomposition, impregnation or mechanical mixing. Preferably, this selective sulfur adsorbent is produced by coprecipitation or decomposition. The method chosen should guarantee that there has been an intensive blending of the components of the selective sulfur adsorbent.

The specific pore volume of the iron oxide/manganese compound(s) adsorbent produced by those procedures determined by mercury porosimetry is preferably from about 0.3 cc/g to about 0.6 cc/g. In addition, this selective sulfur adsorbent preferably has a compacted bulk density of about 0.4 to about 1.1 g/cc. Once the material is in its preliminary product form, it can be further processed to form the final selective sulfur adsorbent by pelletizing or extrusion. This selective sulfur adsorbent preferably is formed into moldings, especially in the form of spheres or pellets, preferably ranging in size from about 0.1 cm to about 1 cm in diameter. The surface area of this selective sulfur adsorbent is at least about 100 m²/g and preferably from about 100 m²/g to about 300 m²/g.

The ratio of this iron oxide/manganese compound(s) with alumina selective sulfur adsorbent to the calcium exchanged zeolite adsorbent is from about 1:4 to about 4:1, preferably 1:3 to about 3:1, by volume. The sequence of utilization of this selective sulfur adsorbent in the sequential sulfur adsorbent bed system with the calcium exchanged zeolite adsorbent preferably places the calcium exchanged zeolite adsorbent prior to this selective sulfur adsorbent.

This iron oxide/manganese compound(s) selective sulfur adsorbent when used alone has shown especially good sulfur adsorption when the sulfur compounds contained in a fuel cell fuel stream comprise hydrogen sulfide, carbonyl sulfide (COS), tertiary butyl mercaptan (TBM) and ethyl mercaptan (EM). This selective sulfur adsorbent, when utilized with the calcium-exchanged zeolite adsorbent, has shown enhanced utility for adsorption of additional sulfur compounds that are commonly present in a fuel cell fuel stream including tetra hydro thiophene (THT) and dimethyl sulfide (DMS), especially when the zeolite is placed in sequence before the iron oxide/manganese adsorbent compound(s) in the sequential sulfur adsorbent bed system. However, some common hydrocarbon fuel streams do not contain these additional sulfur compounds. In this circumstance use of only the iron oxide\manganese compound(s) selective sulfur adsorbent without the calcium-exchanged zeolite adsorbent is an alternative preferred embodiment.

Other selective sulfur adsorbents can be utilized in combination with this selective sulfur adsorbent and zeolite adsorbent for the adsorption of particular sulfur compounds from a hydrogen generation system, such as a hydrocarbon fuel cell feed stream. For example, particularly useful combinations contain the calcium exchanged zeolite adsorbent with this iron oxide/manganese compound(s) with high surface area alumina selective sulfur adsorbent and also include a selective sulfur adsorbent containing carbon with copper oxide or copper oxide/zinc oxide with alumina. These selective sulfur adsorbents are described in more detail later in this specification. The sequence of utilization of these additional selective sulfur adsorbents with the zeolite adsorbent preferably places the zeolite adsorbent prior to the iron oxide/manganese compound(s) with high surface area alumina with the carbon/copper oxide or the copper oxide/zinc oxide with alumina selective sulfur adsorbent placed first in the sequence of the sequential sulfur adsorbent bed stream.

In one preferred embodiment of this combination, the zeolite adsorbent preferably comprises an amount equal to, or greater than, the quantity of the other components in the three component system in the sequential sulfur adsorbent bed, with quantities of the zeolite adsorbent up to about 80% of the total sulfur adsorbents present in the sequential sulfur adsorbent bed system with the iron oxide/manganese compound(s) with alumina selective sulfur adsorbent comprising up to 20% and the carbon/copper oxide or copper oxide/zinc oxide with alumina selective sulfur adsorbent also comprising up to 20% of the sequential sulfur adsorbent bed system, by volume.

An additional preferred selective sulfur adsorbent that can be utilized with the zeolite adsorbent in the sequential sulfur adsorbent bed system is comprised of one or more manganese compound(s), copper oxide and small quantities of a binder. The manganese compound(s) of this selective sulfur adsorbent may be utilized in any of the forms previously described for the manganese compound of the selective sulfur adsorbent described above. The manganese compound(s) of this selective sulfur adsorbent comprise from about 50 to about 80% and preferably from about 60 to about 75% of this selective sulfur adsorbent, by weight. The copper oxide comprises from about 15 to about 40% and preferably from about 15 to about 30%, by weight, of this selective sulfur adsorbent. The binder comprises from about 5 to 20%, by weight, of this selective sulfur adsorbent. In a preferred embodiment the binder may be selected from a wide variety of clays including bentonite, diatomaceous earth, attapulgite, kaolin, sepiolite, illite and mixtures thereof. More preferably, the binder comprises bentonite clay. Promoters may also be added to this selective sulfur adsorbent to enhance its operating characteristics. This adsorbent is prepared by conventional procedures. The surface area of this manganese compound(s)/copper oxide with binder selective sulfur adsorbent ranges from about 100 to about 300 m²/g, preferably from about 200 to about 300 m²/g.

This manganese compound(s)/copper oxide/binder selective sulfur adsorbent when used alone has shown great utility for the adsorption of hydrogen sulfide, carbonyl sulfide, tertiary butyl mercaptan, ethyl mercaptan and mixtures thereof. In addition, this manganese compound(s)/copper oxide/binder selective sulfur adsorbent, when utilized in sequence with the zeolite adsorbent in the sequential sulfur adsorbent bed system, has shown significant adsorption for sulfur compounds contained in hydrocarbon fuel cell feed streams of the same type as those described above where the selective sulfur adsorbent composition comprises iron oxide, manganese compound(s) and small quantities of a high surface area alumina.

The ratio of this selective sulfur adsorbent with the zeolite adsorbent for the removal of sulfur compounds from a fuel cell fuel stream, particularly natural gas, propane and LPG, is from about 1:4 to about 4:1 and preferably from about 1:3 to about 3:1, by volume.

Other selective sulfur adsorbents, particularly of the same type, in the same quantities, and in the same sequence that may be utilized with the iron oxide/manganese compound(s) with small quantities of high surface area alumina, may also be utilized with this selective sulfur adsorbent and the zeolite adsorbent to form a three component system to enhance the adsorption of particular sulfur compounds that are present in a fuel cell fuel stream. The choice of the particular selective sulfur adsorbent or adsorbents used can be adjusted depending on the particular sulfur compounds that are present in the feed stream and their quantity.

An additional selective sulfur adsorbent that can be utilized with the zeolite adsorbent in the sequential sulfur adsorbent bed system in place of, or in addition to, the above described selective sulfur adsorbents comprises zinc oxide alone or in combination with a carrier. While alumina is the preferred carrier, other carriers with similar performance characteristics can be utilized. In a preferred embodiment, the zinc oxide comprises at least about 60%, preferably from about 60 to about 95%, and more preferably from about 70 to about 90%, by weight, of the selective sulfur adsorbent with the remaining portion preferably comprising alumina. Additives may be added to this selective sulfur adsorbent to enhance its capacity to absorb sulfur compounds or other performance characteristics. The surface area of this selective sulfur adsorbent ranges from 5 to about 75 m²/g and preferably from about 10 to about 50 m²/g. This zinc oxide/alumina selective sulfur adsorbent is prepared by conventional procedures.

The zinc oxide alumina selective sulfur adsorbent when used alone as a sulfur adsorbent has shown good sulfur adsorption when the sulfur compounds contained within the fuel cell fuel stream comprise hydrogen sulfide and ethyl mercaptan and mixtures thereof.

The inventors have discovered that enhanced adsorption of sulfur compounds occurs when this zinc oxide with alumina selective sulfur adsorbent is utilized in a sequential sulfur adsorbent bed system with the zeolite adsorbent of the invention. Preferably, the order of the adsorbents in the sequential sulfur adsorbent bed system utilizes the zinc oxide with alumina selective sulfur adsorbent after the zeolite. In a preferred embodiment the ratio of the zinc oxide with alumina selective sulfur adsorbent to the zeolite adsorbent is from about 1:4 to about 4:1 and in a more preferred embodiment, from about 1:3 to about 3:1, by volume. Although the sequential sulfur absorbent bed system chosen may contain only the zinc oxide with alumina selective sulfur adsorbent with the zeolite adsorbent, depending upon the sulfur content and composition within the fuel cell fuel stream, additional selective sulfur adsorbents may also be utilized as part of the sequential sulfur absorbent bed system either prior to or after the zeolite adsorbent and this selective sulfur adsorbent.

Another selective sulfur adsorbent that can be utilized with the zeolite adsorbent of the invention in the sequential sulfur adsorbent bed system is comprised of activated carbon containing small quantities of copper oxide. In a preferred embodiment the activated carbon comprises from about 80 to about 95%, preferably 85 to 95%, by weight, of this selective sulfur adsorbent with the remaining portion comprising copper oxide. Additives may be added to the composition to enhance its performance. The activated carbon/copper oxide selective sulfur adsorbent is prepared by conventional procedures. The surface area of the composition ranges from about 300 to about 1000 m²/g, with the preferred surface area being from about 500 m²/g to about 1000 m²/g. This selective sulfur adsorbent is prepared by conventional procedures.

This activated carbon with copper oxide selective sulfur adsorbent when used alone has shown great utility for the adsorption of tetra hydro thiophene, tertiary butyl mercaptan, ethyl mercaptan and mixtures thereof.

The quantity of the activated carbon/copper oxide selective sulfur adsorbent to be utilized with the zeolite adsorbent is at a ratio of about 1:4 to about 4:1, preferably 1:3 to about 3:1, by volume. Further, the preferred sequence of utilization of the selective sulfur adsorbent and the zeolite adsorbent places the zeolite adsorbent ahead of the activated carbon/copper oxide selective sulfur adsorbent in the sequential sulfur adsorbent bed system.

This activated carbon with copper oxide selective sulfur adsorbent has also shown good adsorption capability when used in combination with other selective sulfur adsorbents and the zeolite adsorbent for the adsorption of a broad range of sulfur compounds contained in a fuel cell feed stream.

Another useful selective sulfur adsorbent that can be utilized with the zeolite adsorbent in a sequential sulfur adsorbent bed system comprises copper oxide and zinc oxide with alumina, preferably with small quantities of carbon. In a preferred embodiment the copper oxide comprises from about 50 to about 65% and more preferably from about 50 to about 60% of the selective sulfur adsorbent, by weight. The zinc oxide comprises from about 20 to about 35% of the selective sulfur adsorbent and the alumina comprises from about 5 to about 20%, preferably from about 10 to 20% of the selective sulfur adsorbent, by weight. The quantity of the carbon, if used, should be less than 10%, preferably from about 1 to about 10%, by weight. The surface area of this selective sulfur adsorbent containing copper oxide, zinc oxide, alumina, and preferably small quantities of carbon, is from about 100 to about 300 m²/g and preferably from about 100 to about 200 m²/g. The process for the preparation of this selective sulfur adsorbent is conventional.

This copper oxide/zinc oxide/alumina, preferably with small quantities of carbon, selective sulfur adsorbent when used alone is especially useful for the adsorption of hydrogen sulfide, tertiary butyl mercaptan, ethyl mercaptan, carbonyl sulfide and mixtures thereof.

The ratio of this selective sulfur adsorbent to the zeolite adsorbent when used in the sequential sulfur adsorbent bed system is from about 1:4 to about 4:1, preferably from 1:3 to about 3:1, by volume. When the sulfur compound(s) to be removed from the fuel cell fuel stream include the sulfur compounds for which this selective sulfur adsorbent is especially useful, the sequence for utilization of this selective sulfur adsorbent with the zeolite adsorbent requires the zeolite adsorbent to be placed prior to this selective sulfur adsorbent in the sequential sulfur adsorbent bed system. In addition to the utilization of the copper oxide/zinc oxide/alumina and preferably with carbon selective sulfur adsorbent, other selective sulfur adsorbents may also be utilized, either prior to or after this selective sulfur adsorbent in the sequential sulfur adsorbent bed system of the invention.

An additional selective sulfur adsorbent that can be utilized with the zeolite adsorbent in the sequential sulfur adsorbent bed system, comprises manganese compound(s), used alone, which may be utilized in a number of forms including MnO₂, Mn₂O₃, Mn₃O₄ and Mn(OH)₄ or mixtures thereof. The surface area of the manganese compound(s) range from about 100 to about 300 m²/g, and preferably from about 200 to about 300 m²/g. Additional materials may be combined with the manganese compound(s) including calcium, silver and magnesium to promote the performance of the manganese compound(s). Conventional methods are utilized for the formation of this selective sulfur adsorbent.

The manganese compound(s) selective sulfur adsorbent when used alone has shown great utility for the adsorption of hydrogen sulfide, tertiary butyl mercaptan, ethyl mercaptan and mixtures thereof.

When used with the zeolite adsorbent in the sequential sulfur adsorbent bed system, the ratio of the manganese compound(s) utilized to the zeolite adsorbent is from about 1:4 to about 4:1 and preferably from about 1:3 to about 3:1, by volume. The sequence of utilization of this manganese compound(s) selective sulfur adsorbent in the sequential sulfur adsorbent bed system is preferably for the zeolite sulfur adsorbent to be placed prior to the manganese compound(s) selective sulfur adsorbent. In addition to the use of the manganese compound(s) and the zeolite adsorbent, other selective sulfur adsorbents described herein may be utilized prior to or after the manganese compound(s) selective sulfur adsorbent in the sequential sulfur adsorbent bed system of the invention.

An additional selective sulfur adsorbent, that can be utilized with the zeolite adsorbent in the sequential sulfur adsorbent bed system, comprises copper oxide with alumina, wherein the quantity of the copper oxide is from about 5 to about 25%, preferably from about 10 to about 20%, by weight, and the quantity of the alumina is from about 75 to about 95%, preferably from about 80 to about 90%, by weight. The surface area of this selective sulfur adsorbent is from about 100 to about 300 m²/g and preferably from about 150 to about 300 m²/g. This selective sulfur adsorbent is prepared by conventional procedures.

This selective sulfur adsorbent when used alone has shown particularly usefulness for the adsorption of hydrogen sulfide, carbonyl sulfide, tertiary butyl mercaptan, ethyl mercaptan and mixtures thereof. In addition, this copper oxide with alumina selective sulfur adsorbent, when utilized in sequence with the zeolite adsorbent in the sequential sulfur adsorbent bed system, has shown significant adsorption for sulfur compounds contained in fuel cell feed streams of the same type as are described above. When used in the sequential sulfur adsorbent bed system for the adsorption of sulfur compounds with the zeolite adsorbent, the ratio of the selective sulfur adsorbent to the zeolite adsorbent is from about 1:4 to about 4:1, preferably from about 1:3 to about 3:1, by volume. The sequence of utilization of this selective sulfur adsorbent with the zeolite adsorbent in the sequential sulfur adsorbent bed system is preferably for the zeolite adsorbent to be placed prior to the selective sulfur adsorbent. Other selective sulfur adsorbents may also be utilized with this selective sulfur adsorbent for the absorption of sulfur compounds in the sequential sulfur adsorbent bed system of the invention.

An additional selective sulfur adsorbent, that can be utilized with the zeolite adsorbent in the sequential adsorbent bed system, comprises copper oxide, zinc oxide and alumina, with the quantity of copper oxide being from about 15 to about 25%, the quantity of the zinc oxide being from about 5 to about 15%, and the quantity of the alumina being from about 65 to about 85%, by weight. The surface area of this selective sulfur adsorbent is from about 100 to about 300 m²/g, preferably from about 150 to 300 m²/g. This selective sulfur adsorbent catalyst is prepared by conventional procedures.

This selective sulfur adsorbent when used alone is particularly useful for the adsorption of hydrogen sulfide, carbonyl sulfide, tertiary butyl mercaptan, ethyl mercaptan, and mixtures thereof.

When used with the zeolite adsorbent, the preferred ratio of this selective sulfur adsorbent with the zeolite adsorbent is from about 1:4 to about 4:1 and preferably from about 1:3 to about 3:1, by volume. The sequence of use of this selective sulfur adsorbent with the zeolite adsorbent is preferably for the zeolite adsorbent to be placed prior to the selective sulfur adsorbent. This selective sulfur adsorbent may be utilized with other selective adsorbents as well as with the zeolite adsorbent and is a particularly preferred option, as discussed above. For example, in one particularly preferred embodiment, this selective sulfur adsorbent is utilized with the zeolite adsorbent and with the iron oxide, manganese compounds and alumina selective sulfur adsorbent, as previously described.

The inventors have surprisingly discovered that the selective sulfur adsorbents described above work best when utilized within a sequential sulfur adsorbent bed system containing one or more of the selective sulfur adsorbents and the zeolite adsorbent. While several types of ion exchanged zeolites may be useful as the zeolite adsorbent, the preferred ion exchange zeolite is a calcium exchanged zeolite. While a number of calcium exchanged zeolites are known, including calcium exchanged zeolite A, zeolite X, zeolite Y, zeolite ZSM-5, zeolite Beta, synthetic mordenite and blends thereof, the preferred calcium exchanged zeolite is a calcium exchanged zeolite X. A particularly preferred calcium exchanged zeolite X is calcium exchanged, low silica zeolite X, known as “LSX”, or calcium exchanged low silica faujasite, known as “LSF”. Zeolite X generally has a Si:Al equivalent ratio of about 1.0 to about 1.25. In one common example, a conventional, non-calcium exchanged precursor synthesized LSF has the following anhydrous chemical composition: 2.0 SiO₂:Al₂O₃:0.73 Na₂O:0.27K₂O, although the ratio between sodium and potassium cations can vary, sometime significantly, depending upon the process of manufacture of the LSF.

For the present invention, a substantial percentage of the cations of the zeolite X are ion exchanged with calcium ions using conventional ion exchange procedures, such as by treatment of the zeolite X with calcium salts, such as, but not limited to, calcium chloride. Several methods can be used for the ion exchange procedure with ion exchange preferably occurring after the zeolite adsorbent has been formed into its preferred final form, such as a bead or an extrudate. The zeolite X is ion exchanged to a level of at least about 50%, preferably at least 60%, more preferably at least 70%, and most preferably 85 to 95% of the exchangeable metal ions. The remaining ions may be sodium and/or potassium ions. (For reference purposes the term “calcium exchanged zeolite X” means a zeolite X containing at least about 50% calcium cations.)

The calcium exchanged zeolite X of the invention generally contains sodium or potassium ions in addition to the calcium ions after the calcium ion exchange. However, a portion or substantially all of these sodium/potassium ions can be ion exchanged with other cations to enhance or modify the performance characteristics of the calcium exchanged zeolite X, especially for sulfur adsorption. For example, additional cations that may be ion exchanged onto the zeolite X to enhance its performance include zinc, cadmium, cobalt, nickel, copper, iron, manganese, silver, gold, scandium, lithium and combinations thereof. The percentage of ion exchange of these additional metal ions can range from as little as about 1% up to about 40% or so, depending upon the level of calcium exchange of the zeolite X. The particular metal ions that are ion exchanged onto the calcium exchanged zeolite depend on the particular sulfur compounds which are intended to be removed from the fuel cell fuel stream by the sequential sulfur adsorbent bed system of the invention.

The calcium exchanged zeolite, when utilized above as a sulfur adsorbent, has shown significant capability for the adsorption of various sulfur materials, particularly tetra hydro thiophene (THT), di-methyl sulfide (DMS), tertiary butyl mercaptan (TBM) and ethyl mercaptan (EM).

In addition, it has been surprisingly discovered that the capability of the selective sulfur adsorbents described above, when used individually, and the calcium exchanged zeolite, when used individually, can be enhanced dramatically by the combination use of the calcium exchanged zeolite X with the selective sulfur adsorbents to form the sequential sulfur adsorbent bed system for the desulfurization of a hydrocarbon fuel cell feed stream. The use of this combination of the selective sulfur adsorbent with the calcium exchanged zeolite permits the adsorption of a broader range of sulfur containing compounds than has been conventionally been adsorbed using either component alone. For example, it has been surprisingly discovered that by the use of the selective sulfur adsorbents mentioned above in combination with the calcium exchanged zeolite X described above, enhanced sulfur adsorption of a broader range of sulfur compounds, including carbonyl sulfide, hydrogen sulfide, tetra hydro thiophene, dimethyl sulfide, and various mercaptans, including ethyl, methyl, propyl, and tertiary butyl mercaptan and combinations thereof, is possible.

It has also been surprisingly discovered that the breakthrough time for all sulfur compounds commonly present in a hydrocarbon fuel system can be extended by the use of one or more selective sulfur adsorbents with the calcium exchanged zeolite X and by arranging the order of the components correctly within the sequential sulfur adsorbent bed system.

It has also been surprisingly discovered that by placement of the calcium exchanged zeolite X prior to one or more of the selective sulfur adsorbents in the sequential sulfur adsorption bed system, the likelihood of the production of synthesized sulfur compounds is substantially reduced.

The inventors have also surprisingly discovered that the sequential sulfur adsorbent bed system of the invention can be utilized at temperatures lower than normally utilized for conventional sulfur adsorption. While conventional chemical sulfur adsorbents require temperatures of the feed stream of at least about 150° C. to about 400° C., the sequential sulfur adsorbent bed system of the invention can be utilized effectively to adsorb the sulfur contaminants at temperatures below 100° C. and is effective for removal of some sulfur compounds at temperatures as low as ambient temperatures. Further, because of the lower temperature of use, the sequential sulfur adsorption bed is easier to use than when higher temperatures are necessary.

In addition, when the sequential sulfur adsorbent bed system of the invention is used, the pressure on the feed stream may be reduced to a range as low as from about 1 bar to about 18 bar, preferably from about 1.7 bar to about 7 bar, pressures lower than normally used for adsorption of sulfur compounds in a conventional fuel cell processing train.

The inventors have also discovered a method for supplying a substantially desulfurized hydrocarbon fuel stream to a fuel cell processor using the sequential sulfur adsorbent bed system described above. In this process a sulfur contaminated hydrocarbon fuel stream is passed over or through the sequential sulfur adsorbent bed system of a fuel cell processor of the invention at a temperature from about ambient to about 100° C., preferably less than 60° C., and more preferably at ambient temperatures. By passing a hydrocarbon fuel stream comprising, for example, natural gas, propane or LPG, containing sulfur components at levels up to 500 ppm, a substantial reduction in the quantity of those sulfur compounds, preferably down to a level of less than about 50 ppb, can be achieved.

The inventors have also discovered that the above-described sequential sulfur adsorbent bed system of the invention can be used in a desulfurizer, particularly for use in a fuel cell processing train. This desulfurizer includes an inlet for receiving the nondesulfurized hydrocarbon fuel stream, such as natural gas, propane or LPG, the sequential sulfur adsorbent bed system of the invention, as described above, which is placed in a location to desulfurize the hydrocarbon fuel stream, and an outlet where the desulfurized hydrocarbon fuel stream is passed down stream for further processing. For example, the desulfurized hydrocarbon fuel stream can be passed through the fuel cell processing train to the fuel cell stack for the production of electricity.

The inventors have also surprisingly discovered that this method for supplying a substantially desulfurized hydrocarbon fuel stream is more advantageous than conventional desulfurization systems as it permits desulfurization of a broader range of sulfur compounds, increases the breakthrough time for the system, reduces the production of synthesized sulfur compounds, reduces the required temperature and pressure of the feed stream and permits the choice of different combinations and quantities of selective sulfur adsorbents to be used in the sequential sulfur adsorbent bed system depending on the sulfur compounds that are present in the particular feed stream. The compositions and methods of the invention also permit the production of a substantially desulfurized hydrocarbon fuel stream to levels of sulfur below those of conventional desulfurizing processes.

The inventors have also discovered that the sequential sulfur adsorbent bed system of the invention can be used in fuel cell processors for a longer period of time than conventional adsorbents and still achieve high levels of sulfur absorbency.

The inventors have also discovered that the sequential sulfur adsorbent bed system of the invention is also not subject to desorption of the adsorbed sulfur compounds when the conditions surrounding the catalyst bed change, as often occurs with some conventional sulfur adsorbents.

### EXAMPLES

The following examples are intended to be illustrative of the present invention and to teach one of ordinary skill in the art to make and use the invention. These examples are not intended to limit the invention in any way.

In order to illustrate the operation of the invention, the inventors have compared the performance of various sulfur adsorbents, when used alone and in combination. In each example, a synthetic natural gas feed stream is utilized comprising 93% methane, 3% ethane, 2% propane, 0.2% butane, 1% carbon dioxide and 0.75% nitrogen. Also included in this synthetic natural gas is 10 ppm (as sulfur) of each of either tert-butyl mercaptan or ethyl mercaptan (“mercaptan”) and tetra hydro thiophene (“THT”). This synthetic natural gas is passed through an artificial reactor containing 10 cc of the selected sulfur adsorbent or adsorbents in a bed. When two sulfur adsorbents are used in combination, the quantity of the adsorbents is 7.5 cc of the zeolite sulfur adsorbent, as described in Example 1, and 2.5 cc of the selective sulfur adsorbent, as described in Example 2. The zeolite adsorbent is in the form of 2 mm spheres. The selective sulfur adsorbent is a 1.18 mm×0.85 mm mesh particulate typically produced from 1.6 mm extrudates by grinding. The adsorbents are sized and loaded into the reactor and the synthetic natural gas feed stream is passed through the reactor. The temperature of the feed stream is maintained at 38° C. with a space velocity of 1500 hr⁻¹ at a pressure of 2 bar. “Breakthrough” for this test occurs when greater than 50 ppb of sulfur is observed in the natural gas feed stream after passage through the adsorbent bed. To determine the gas phase sulfur level of the feed stream, analysis was performed using an Agilent 6890 gas chromatograph attached to an Antek 7090 sulfur analyzer. The gas chromatograph utilizes a 60 m×320 micron DB-1 capillary column for sulfur compound separation. The Antek 7090 utilizes a sulfur chemiluminescense detector (SCD) for sulfur detection. The operational detection limit for the system is approximately 50 ppb (mole). The test unit is controlled by automation software.

### Example 1

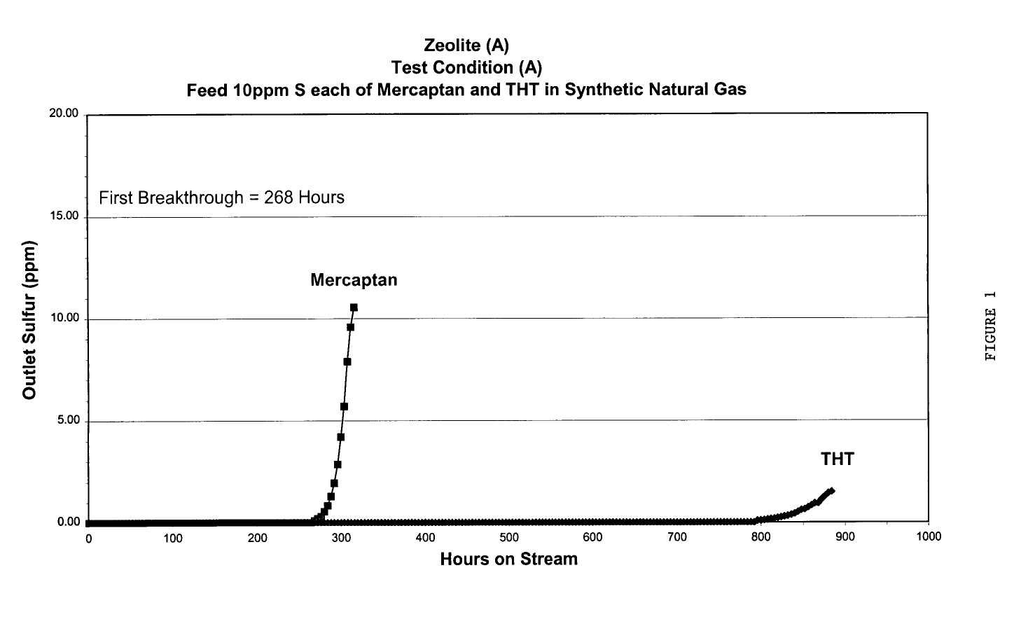

The synthetic natural gas containing mercaptan and THT is passed through a reactor containing only calcium exchanged zeolite X. The zeolite X has an Si:Al equivalent ratio of 1.17 and a calcium exchange of 70% with the remaining metal ions comprising sodium and/or potassium. The temperature of the reactor is maintained at 38° C. and the pressure is maintained at about 2 bar. The sulfur adsorbency of the calcium exchanged zeolite is shown in FIG. 1, which shows a first breakthrough for the mercaptan at 268 hours.

### Example 2

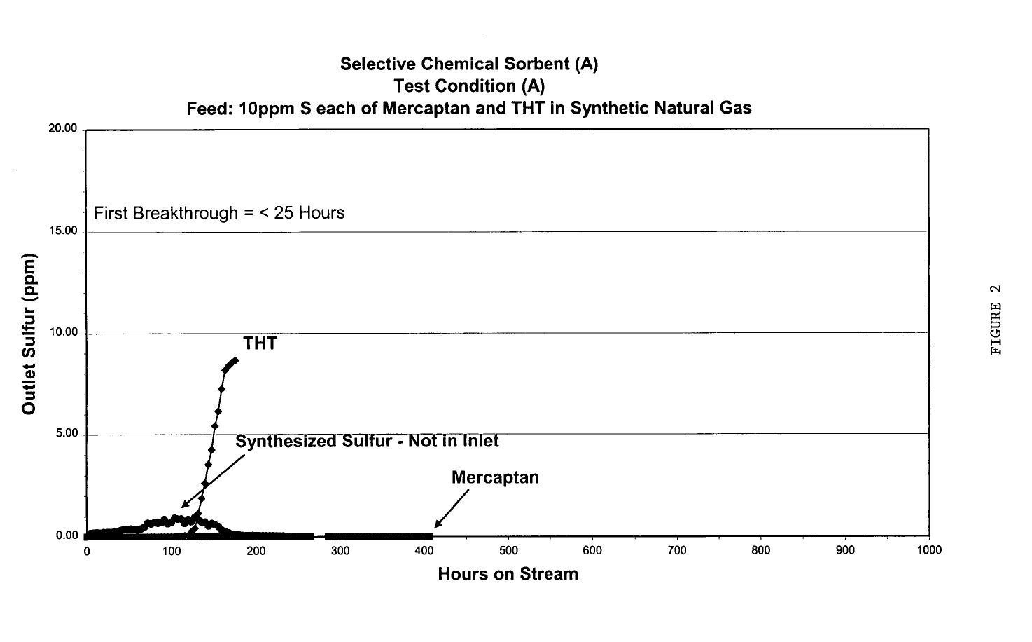

The synthetic natural gas containing mercaptan and THT is passed through a reactor containing only a selective sulfur adsorbent comprising 34% by weight manganese compounds, 54% iron oxide comprising Fe₂O₃ and 12% alumina with a surface area of 294 m²/g. The performance of this selective sulfur adsorbent is shown in FIG. 2, wherein the first breakthrough occurs at less than 25 hours. The sulfur compound(s) that is produced at that time is a “synthesized sulfur compound” as the breakthrough for THT does not occur until after 100 hours. It is believed that the “synthesized sulfur compounds” is at least one higher molecular weight sulfur compound produced from the interaction of the THT and/or the mercaptan with the selective sulfur adsorbent.

### Example 3

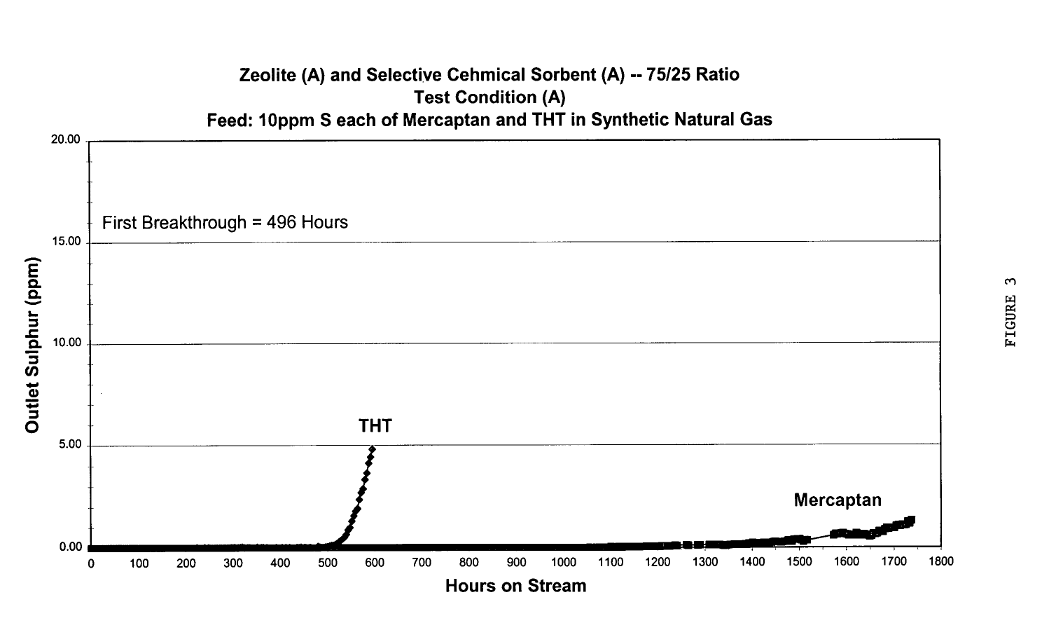

A further test was run wherein the calcium exchanged zeolite of Example 1 is used in combination with the selective sulfur adsorbent of Example 2 in the reactor. Seventy-five percent of the sulfur adsorbents by volume comprised the zeolite and 25% comprised the selective sulfur adsorbent. 10 ccs of the combined adsorbents are used. The zeolite was placed ahead of the selective sulfur adsorbent in the reactor. Otherwise, the operating conditions and the composition of the feed stream are the same as for Examples 1 and 2. When the feed stream is passed through the reactor, breakthrough does not occur until 496 hours as shown in FIG. 3.

As is clear from these examples, the combination of the calcium exchanged zeolite with the selective sulfur adsorbent increases the time of sulfur breakthrough, prevents the formation of synthesized sulfur compounds and extends the lifetime of the sequential sulfur adsorbent bed system.

As many changes and variations in the disclosed embodiments may be made without departing from the inventive concept, the invention is not intended to be limited.

1. A process for desulfurization of a hydrocarbon feed stream comprising
providing a hydrocarbon feed stream, which is contaminated with sulfur compounds,
passing the sulfur contaminated feed stream through a sequential sulfur adsorbent bed system comprising a selective sulfur adsorbent and a calcium exchanged zeolite sulfur adsorbent to produce a hydrocarbon feed stream which has been substantially desulfurized.

2. The process of claim 1, wherein the temperature of the sequential sulfur adsorbent bed system, as the feed stream passes therethough, is from ambient to about 100° C.

3. The process of claim 1, wherein the pressure on the feed stream is from about 1 bar to about 18 bar.

4. The process of claim 1, wherein the selective sulfur adsorbent comprises a manganese-based adsorbent.

5. The process of claim 1, where the calcium exchanged zeolite sulfur adsorbent comprises a calcium exchanged zeolite X or LSX.

6. The process of claim 1, wherein the selective sulfur absorbent catalyst comprises ZnO.

7. The process of claim 1, wherein the selective sulfur absorbent catalyst comprises CuO and carbon.

8. The process of claim 1, wherein the selective sulfur absorbent catalyst comprises CuO, ZnO and a carrier.

9. The process of claim 1, wherein the selective sulfur adsorbent comprises CuO, a manganese compound and a binder.

10. The process of claim 1, wherein the selective sulfur absorbent comprises CuO and an alumina.

11. The process of claim 1, wherein the selective sulfur absorbent comprises a manganese compound, an iron compound and high surface area alumina.

12. The process of claim 1, wherein the calcium exchanged zeolite is exchanged with calcium ions at least about 50%.

13. The process of claim 12, wherein the calcium exchanged zeolite is further exchanged with metal ions selected from the group consisting of zinc, cadmium, cobalt, nickel, copper, iron, manganese, silver, gold, scandium, lithium and combinations thereof.

14. The process of claim 1, wherein the Si:Al ratio of the calcium exchanged zeolite is from about 1.0 to about 1.25.

15. The process of claim 1, wherein the feed stream contacts the calcium exchanged zeolite prior to contacting the selective sulfur absorbent.

16. A process for desulfurization of a hydrocarbon fuel cell feed stream comprising
providing a hydrocarbon feed stream to a fuel cell processing train, wherein the feed stream is contaminated with sulfur compounds,
passing the sulfur contaminated feed stream through a sequential sulfur adsorbent bed system comprising a selective sulfur adsorbent and a calcium exchanged zeolite sulfur adsorbent to produce a hydrocarbon feed stream which has been substantially desulfurized, and
delivering the substantially desulfurized hydrocarbon feed stream to remaining components of the fuel cell processing train.

17. The process of claim 16, wherein the temperature of the sequential sulfur adsorbent bed system as the feed stream passes therethough is from ambient to about 100° C.

18. A process for the desulfurization of a hydrocarbon fuel cell feed stream comprising
providing the hydrocarbon feed stream to a fuel cell processing train, wherein the feed stream is contaminated with sulfur compounds including one or more compounds selected from the group consisting of carbonyl sulfide, hydrogen sulfide, tetra hydro thiophene, dimethyl sulfide, mercaptans, disulfides, thiophenes, sulfoxides, other organic sulfides, and higher molecular weight organic sulfur compounds and combinations thereof,
passing the sulfur contaminated feed stream through a sequential sulfur adsorbent bed system comprising a calcium exchange zeolite X and a manganese-based selective sulfur adsorbent to produce a hydrocarbon feed stream which has been substantially desulfurized, and
delivering the substantially desulfurized hydrocarbon feed stream to remaining components of the fuel cell system.

19. The process of claim 18, wherein the temperature of the sequential sulfur adsorbent bed system as the feed stream passes therethrough is from ambient to about 100° C.

20. The process of claim 18, wherein the pressure of the sulfur contaminated feed stream as it passes through the sequential sulfur adsorbent bed system is from about 1 bar to about 18 bar.

21. A sequential adsorbent bed system for use in a fuel cell processing train comprising a selective sulfur adsorbent and a calcium exchanged zeolite, wherein the selective sulfur adsorbent comprises one or more manganese compounds selected from the group consisting of MnO₂, Mn₂O₃, Mn₃O₄ and Mn(OH)₄ and mixtures thereof, iron oxide, and a high surface area support, and wherein the calcium exchanged zeolite comprises a calcium exchanged zeolite X, ion exchanged to at least 50% of the available metal ions with calcium ions.

22. A sequential adsorbent bed system for use in a fuel cell processing train comprising a selective sulfur adsorbent and a calcium exchanged zeolite, wherein the calcium exchanged zeolite comprises a calcium exchanged zeolite X, ion exchanged to at least 50% of the available metal ions with calcium ions, and wherein the selective sulfur adsorbent comprises one or more manganese compounds selected from the group consisting of MnO₂, Mn₂O₃, Mn₃O₄ and Mn(OH)₄ and mixtures thereof, copper oxide and a binder.

23. A sequential adsorbent bed system for use in a fuel cell processing train comprising two selective sulfur adsorbents and a calcium exchanged zeolite, wherein the calcium exchanged zeolite comprises a calcium exchanged zeolite X, ion exchanged to at least 50% of the available metal ions with calcium cations, and wherein a first of the two selective sulfur adsorbents comprises one or more manganese compounds selected from the group consisting of MnO₂, Mn₂O₃, Mn₃O₄ and Mn(OH)₄ and mixtures thereof, iron oxide and a high surface area support and wherein a second of the two selective sulfur adsorbents comprises copper oxide and activated carbon.

24. The sequential adsorbent bed system of claim 21 wherein the calcium exchanged zeolite is placed prior to the selective sulfur adsorbent.

25. The sequential adsorbent bed system of claim 22 wherein the calcium exchanged zeolite is placed prior to the selective sulfur adsorbent.

26. The sequential adsorbent bed system of claim 23, wherein the calcium exchanged zeolite is placed prior to the first selective sulfur adsorbent.

27. The sequential adsorbent bed system of claim 23 wherein the order of the adsorbents in the bed system comprises the second selective sulfur adsorbent, the calcium exchanged zeolite and the first selective sulfur adsorbent.

28. A sequential adsorbent bed system comprising two selective sulfur adsorbents and a calcium exchanged zeolite, wherein the calcium exchanged zeolite comprises a calcium exchanged zeolite X, ion exchanged to at least 50% of the available metal cations with calcium cations, wherein the first of the two selective sulfur adsorbents comprises one or more manganese compounds selected from the group consisting of MnO₂, Mn₂O₃, Mn₃O₄ and Mn(OH)₄ and mixtures thereof, iron oxide and a high surface area support, and wherein a second of the two selective sulfur adsorbents comprises zinc oxide, copper oxide and alumina.

29. The sequential adsorbent bed system of claim 28, wherein the order of the adsorbents in the bed system comprises the second selective sulfur adsorbent, the calcium exchanged zeolite and the first selective sulfur adsorbent.

30. The process of claim 1, wherein the sequential sulfur adsorbent bed system further comprises a second selective sulfur adsorbent.

31. The process of claim 18, wherein the sequential sulfur adsorbent bed system further comprises a second selective sulfur adsorbent.
